(19) United States
(12) Patent Application Publication
(10) Pub. No.: US 2026/0329030 A1
(43) Pub. Date: Oct. 22, 2026

(54) OPTICAL DEVICES AND METHODS OF MANUFACTURE

(71) Applicant: Taiwan Semiconductor Manufacturing Co., Ltd., Hsinchu (TW)

(72) Inventors: Tai-Chun Huang, New Taipei City (TW); Stefan Rusu, Sunnyvale, CA (US)

(21) Appl. No.: 19/718,690

(22) Filed: Jun. 24, 2026

Related U.S. Application Data
(63) Continuation of application No. 18/801,087, filed on Aug. 12, 2024.

(51) Int. Cl. G02B 6/42

(52) U.S. Cl. CPC G02B 6/4213; G02B 6/4246; G02B 6/4283

(57) ABSTRACT

Optical devices and methods of manufacture are presented in which a first set of gratings that is vertically offset and horizontally offset from a second set of gratings. In some embodiments, the first and second set of gratings are present in a single grating layer. In some embodiments, the first and second set of gratings are present in a multilayered grating layer. The one or more layers including the first and second set of gratings are present on a cladding layer.

### CROSS-REFERENCE TO RELATED APPLICATIONS

This application is a continuation of U.S. Application No. 18/801,087, filed on Aug. 12, 2024, which application is hereby incorporated herein by reference.

### BACKGROUND

Electrical signaling and processing is one technique for signal transmission and processing. Optical signaling and processing have been used in increasingly more applications in recent years, particularly due to the use of optical fiber-related applications for signal transmission.

A grating coupler can provide for the coupling of light from an optical fiber to an optical waveguide for use in optical signaling and processing systems. The design of grating couplers typically achieves one-way optical coupling, requiring additional metal reflectors to increase coupling efficiency. One-way coupling can lead to light leakage problems, which in turn reduces coupling efficiency. One-way coupling can also be limited by the polarization selectivity of the grating coupler. Further, the grating coupler can also be the source of energy losses, which in turn can affect the performance of the optical signaling and processing system incorporating the grating coupler.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a side cross-sectional view illustrating an interposer used in a method for forming a photonics platform, in accordance with some embodiments.

FIG. 2 is a side cross-sectional view illustrating processing the interposer to provide first optical devices, in accordance with some embodiments.

FIG. 2A is a side cross-sectional view illustrating forming masking to isolate a grating coupler portion of the interposer and removing a first insulating layer of the interposer in the grating coupler portion, in accordance with some embodiments.

FIG. 2B is a side cross-sectional view illustrating forming a mirror layer and a first cladding layer in the grating coupler portion of the interposer, in accordance with some embodiments.

FIG. 2C is a side cross-sectional view illustrating forming a single grating layer on the first cladding layer, in accordance with some embodiments.

FIG. 2D is a side cross-sectional view illustrating etching trenches into an upper surface of the single grating layer to form a set of gratings, in accordance with some embodiments.

FIG. 2E is a top down view of a grating coupler including a single grating layer, in accordance with some embodiments.

FIG. 2F is a side cross-sectional view illustrating varying grating height in an array of gratings of a grating coupler including a single grating layer, in accordance with some embodiments.

FIG. 2G is a side cross-sectional view illustrating varying trench depth in an array of gratings of a grating coupler including a single grating layer, in accordance with some embodiments.

FIG. 2H is a side cross-sectional view illustrating forming the first grating layer of a multilayered grating structure on a first cladding layer, in accordance with some embodiments.

FIG. 2I is a side cross-sectional view illustrating forming the second grating layer of a multilayered grating structure on the first grating layer, in accordance with some embodiments.

FIG. 2J is a side cross-sectional view illustrating etching trenches into an upper surface of the second grating layer to form a set of gratings, in accordance with some embodiments.

FIG. 2K is a top down view of a grating coupler including a multilayered grating structure, in accordance with some embodiments.

FIG. 2L is a side cross-sectional view illustrating varying trench depth in an array of gratings of a grating coupler including a multilayered grating structure, in accordance with some embodiments.

FIG. 2M is a side cross-sectional view illustrating forming a grating coupler with a multilayered grating structure including three sets of gratings, in accordance with some embodiments.

FIG. 2N is a side cross-sectional view of a grating coupler including three sets of gratings that have been configured for coupling with TM mode and TE mode light having broadband wavelengths, in accordance with some embodiments.

FIG. 2O is a side cross-sectional view of a grating coupler including three sets of gratings that have been configured for coupling with TM mode and TE mode light having C/O wavelengths, in accordance with some embodiments.

FIGS. 3-9 are side cross-sectional views illustrating the formation of a photonics platform integrating a grating coupler as described in FIGS. 2A-2O, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature’s relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be discussed with respect to certain embodiments of optical devices in which at least two sets of gratings that are horizontally and vertically offset from one another are integrated into the grating layer of a grating coupler. In some embodiments, the methods and structures disclosed herein provide a bidirectional grating coupler structure for single and multilayer structures, which reduces energy loss and improves coupling efficiency and bandwidth. In some embodiments, the optical device structures described herein are suitable for different wavelengths of light sources. In some embodiments, a multilayer structure is described that can achieve higher coupling efficiency, wider bandwidth, higher wavelength selectivity, and lower polarization dependence than prior grating couplers. In some embodiments, the bidirectional grating coupler structure described herein is an optical component that can achieve more efficient optical coupling for optical fiber-related applications for signal transmission than previous optical couplers.

However, the embodiments presented herein are intended to be illustrative and are not intended to limit the embodiments to the precise descriptions as discussed. Rather, the embodiments discussed may be incorporated into a wide variety of implementations, and all such implementations are fully intended to be included within the scope of the embodiments.

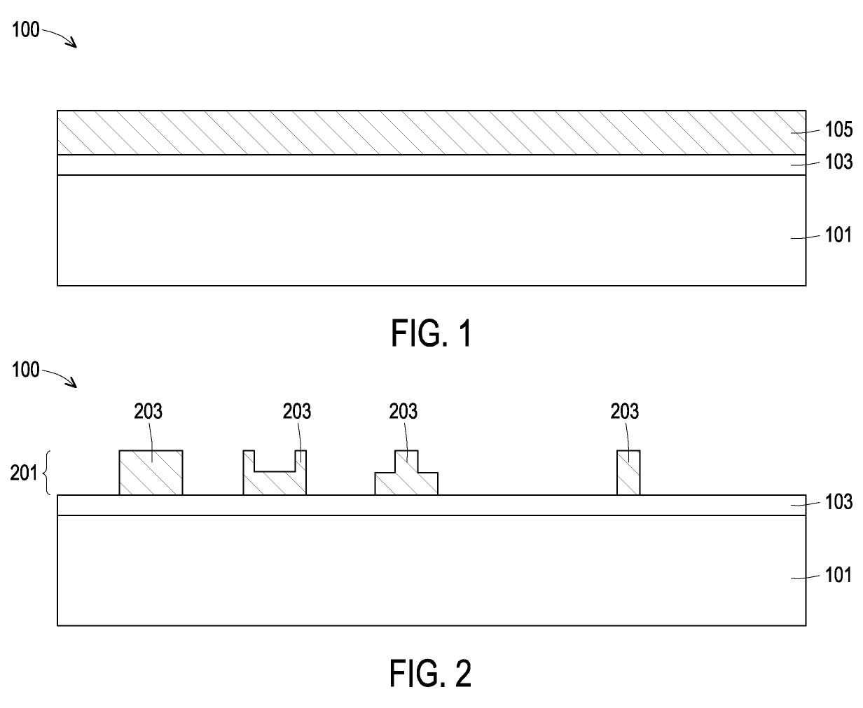

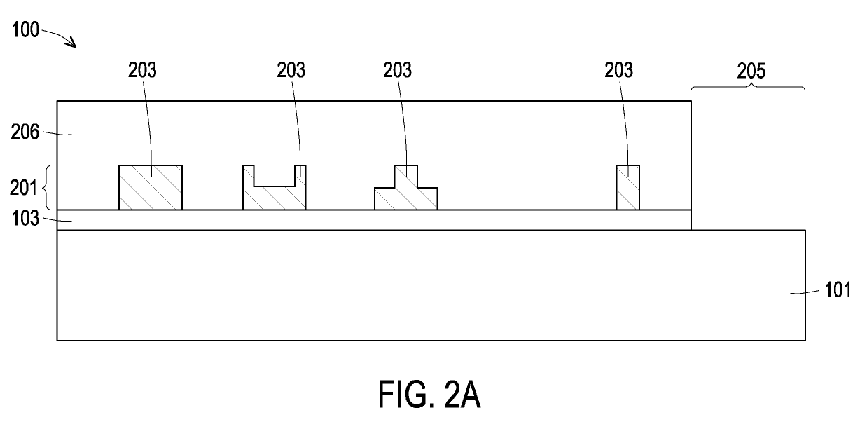

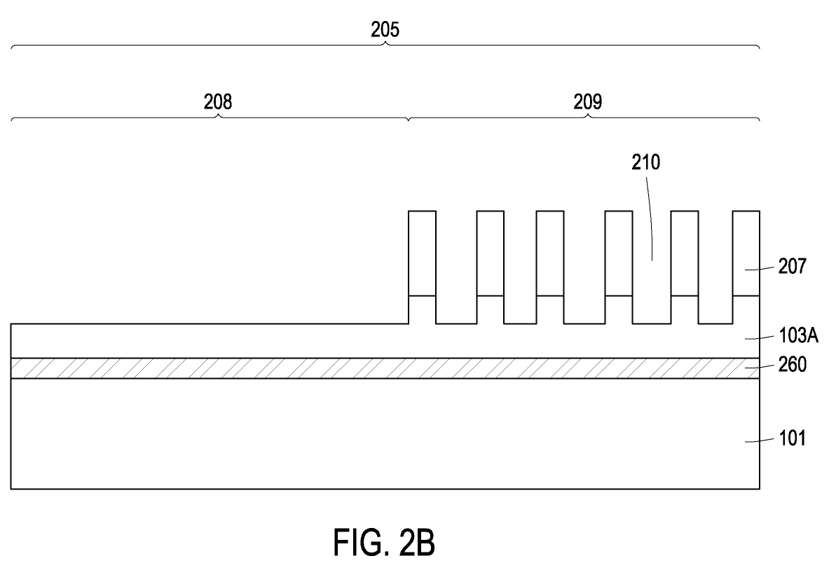

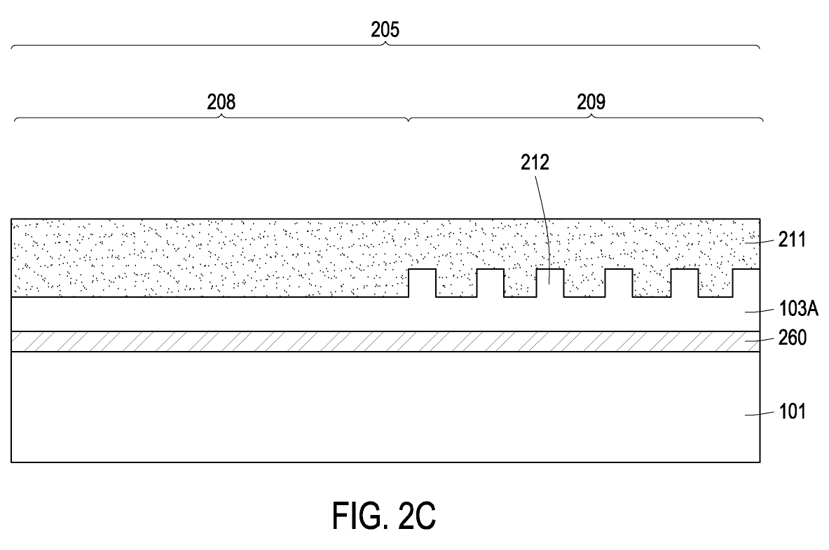

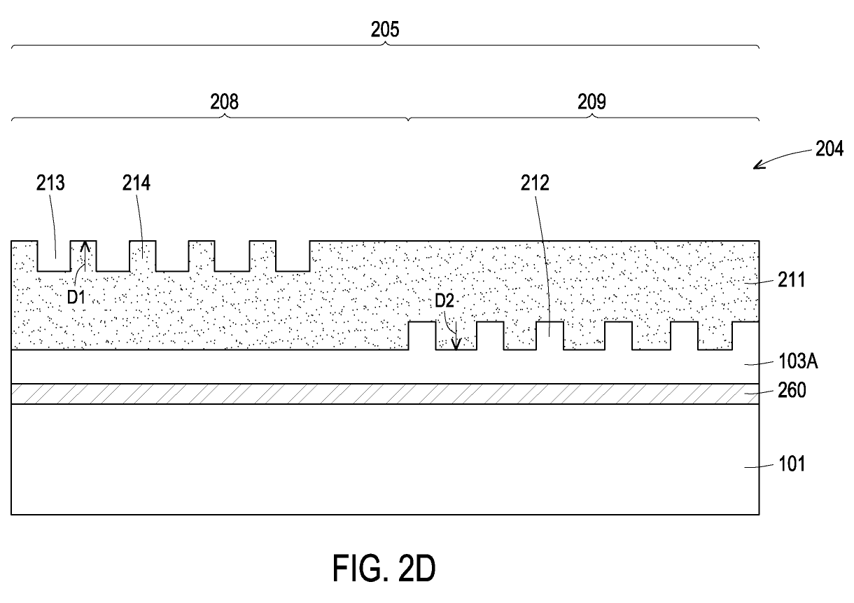

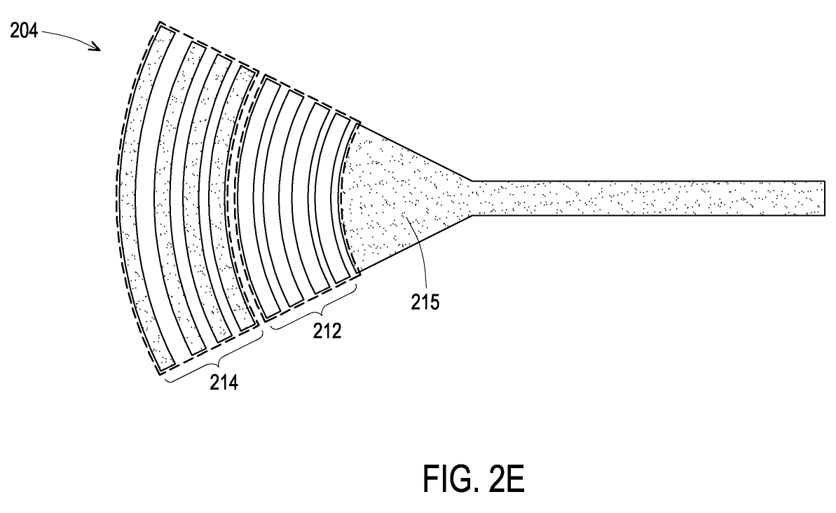

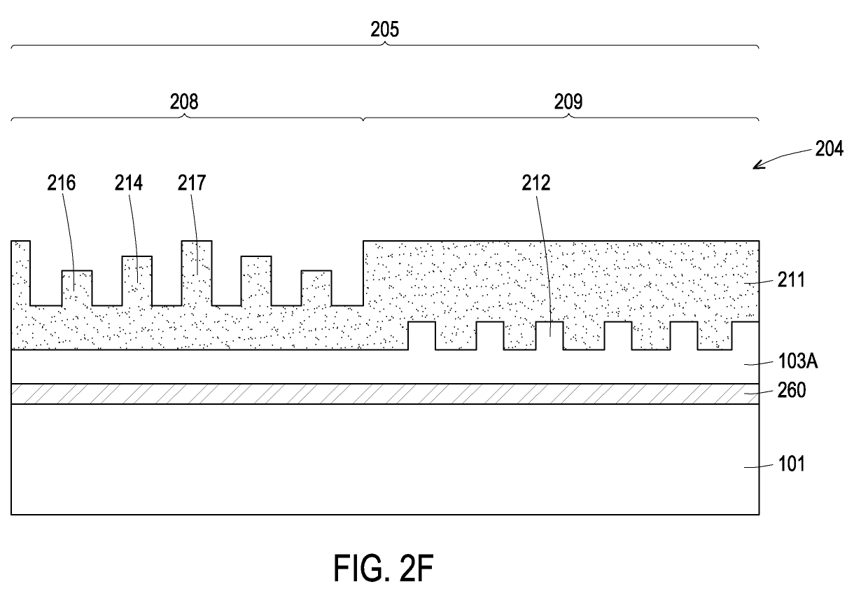

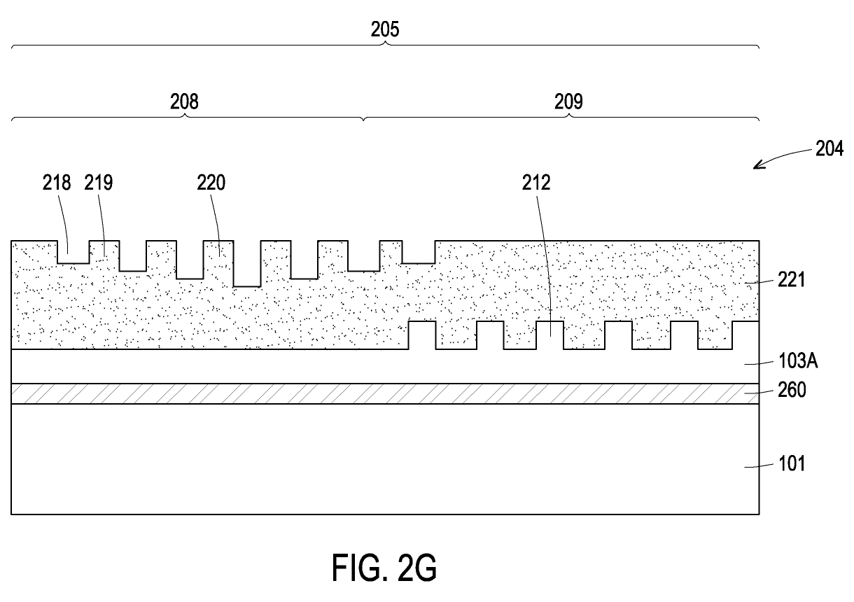

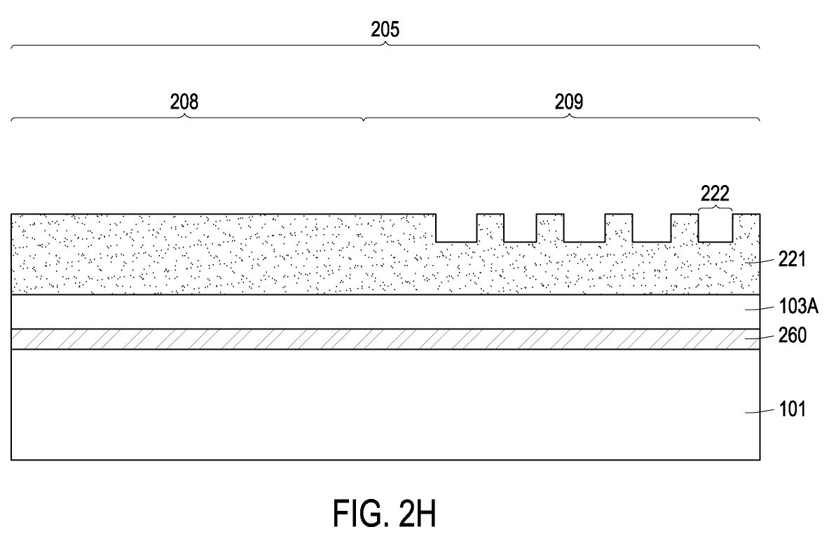

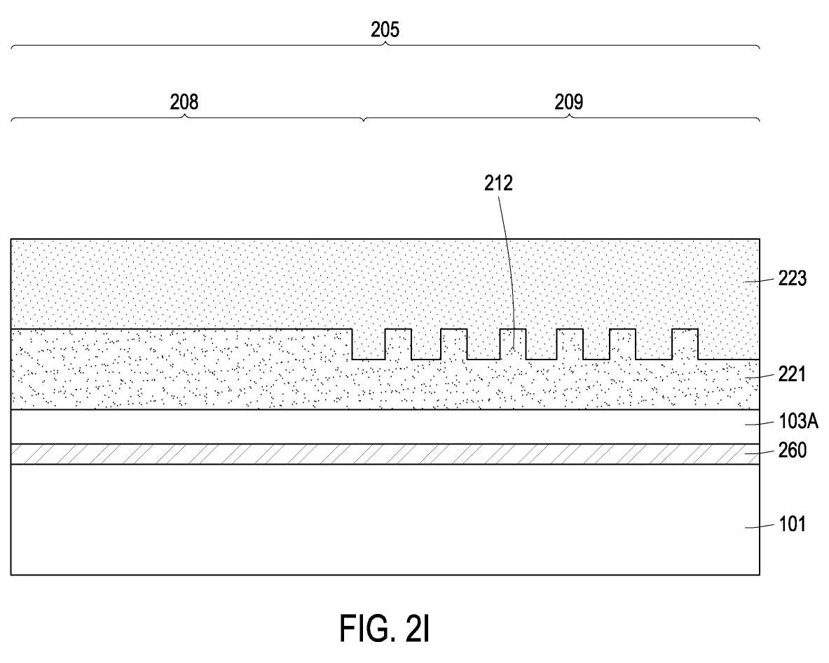

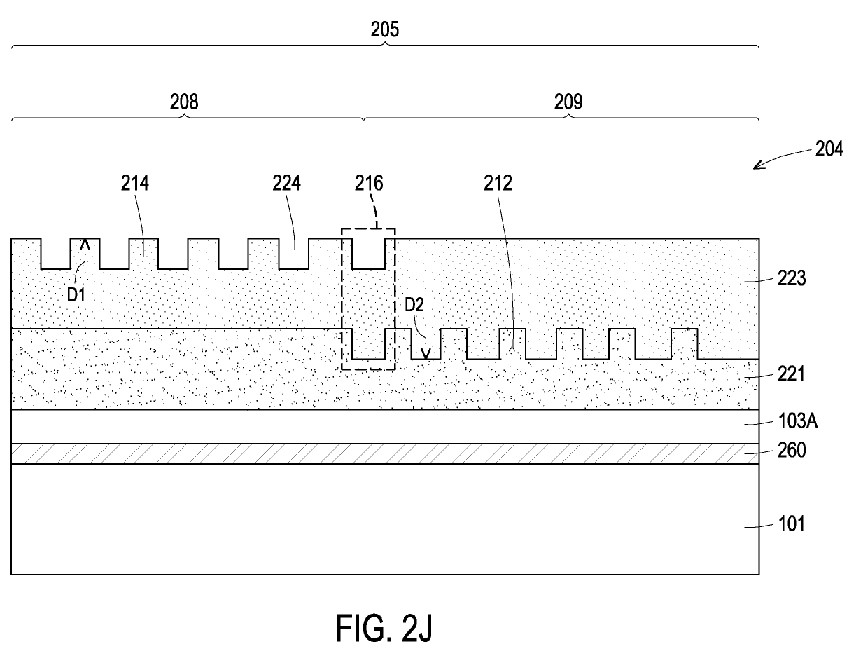

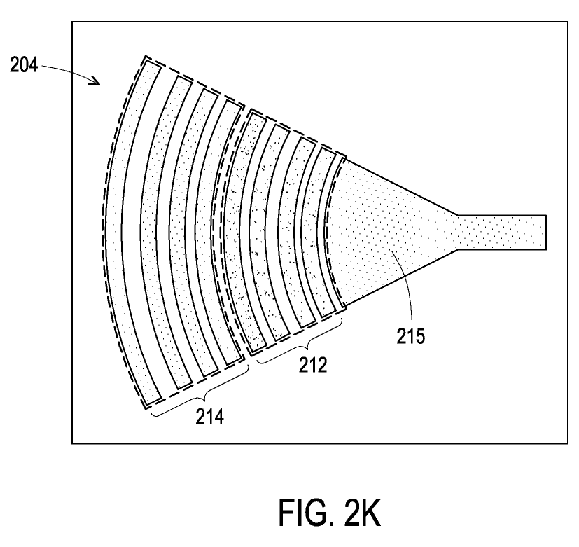

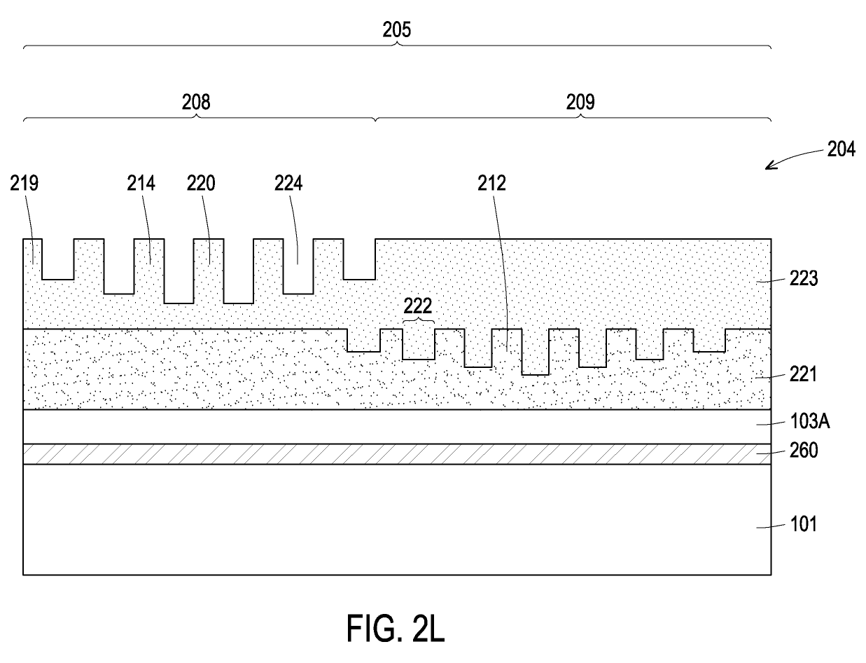

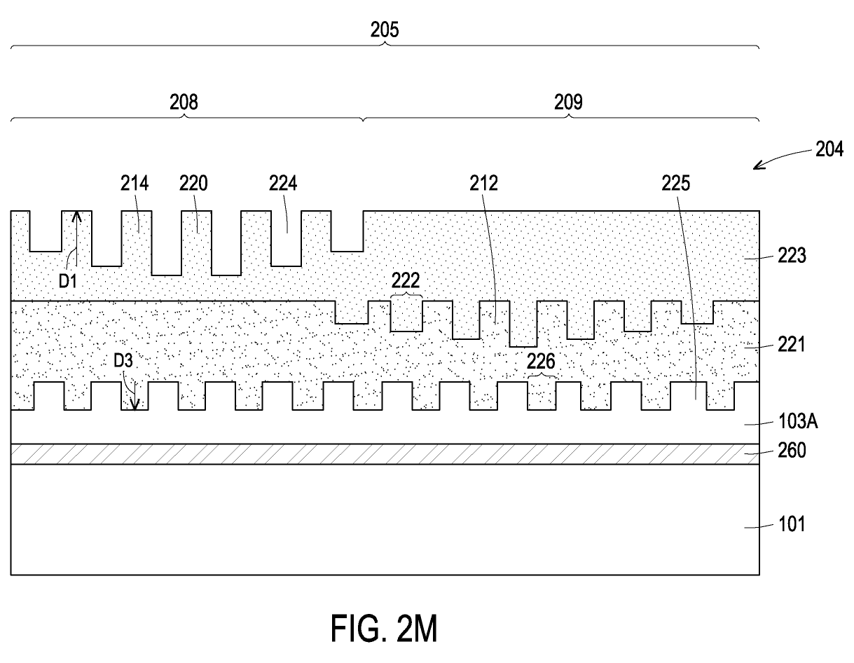

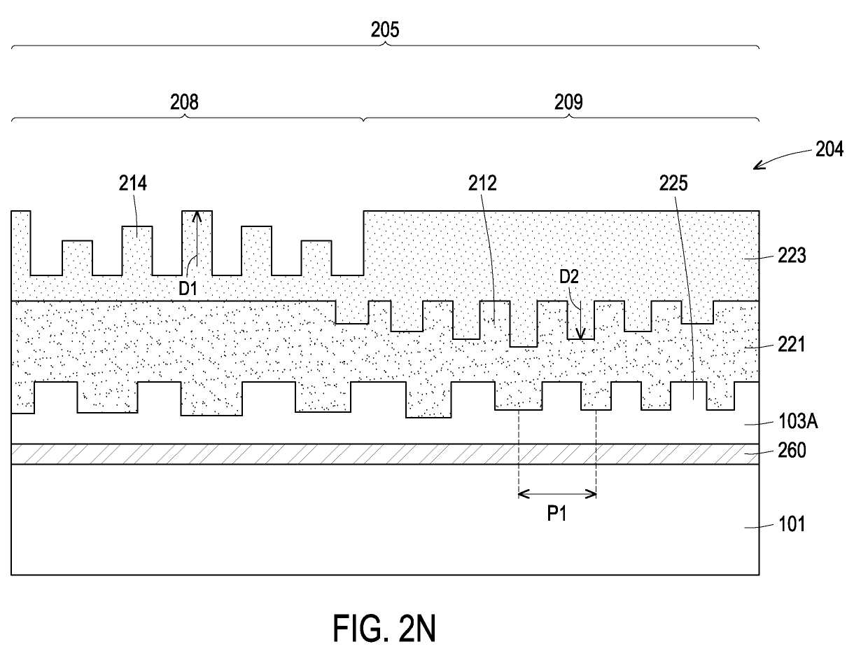

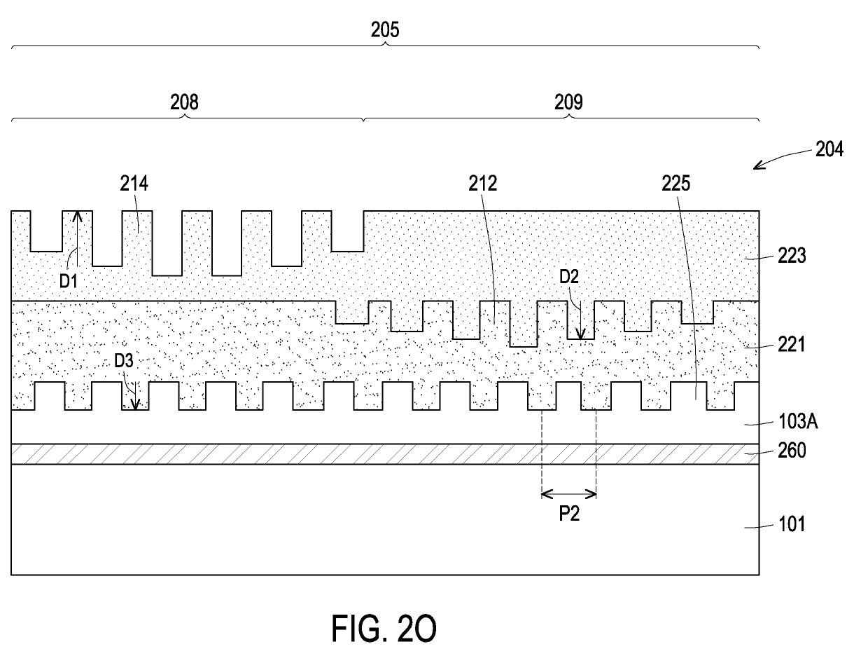

With reference now to FIG. 1, there is illustrated an initial structure of an optical interposer 100. In the particular embodiment illustrated in FIG. 1, the optical interposer 100 is a photonic integrated circuit (PIC) and comprises at this stage a first substrate 101, a first insulator layer 103, and a layer of material 105 for a first active layer 201 of first optical components 203 (not separately illustrated in FIG. 1 but illustrated and discussed further below with respect to FIG. 2). In an embodiment, at a beginning of the manufacturing process of the optical interposer 100, the first substrate 101, the first insulator layer 103, and the layer of material 105 for the first active layer 201 of the first optical components 203 may collectively be part of a silicon-on-insulator (SOI) substrate. Looking first at the first substrate 101, the first substrate 101 may be a semiconductor material such as silicon or germanium, a dielectric material such as glass, or any other suitable material that allows for structural support of overlying devices.

The first insulator layer 103 may be a dielectric layer that separates the first substrate 101 from the overlying first active layer 201 and can additionally, in some embodiments, serve as a portion of cladding material that surrounds the subsequently manufactured first optical components 203 (discussed further below). In an embodiment the first insulator layer 103 may be silicon oxide, silicon nitride, germanium oxide, germanium nitride, combinations of these, or the like, formed using a method such as implantation (e.g., to form a buried oxide (BOX) layer) or else may be deposited onto the first substrate 101 using a deposition method such as chemical vapor deposition, atomic layer deposition, physical vapor deposition, combinations of these, or the like. However, any suitable material and method of manufacture may be used.

The material 105 for the first active layer 201 is initially (prior to patterning) a conformal layer of material that will be used to begin manufacturing the first active layer 201 of the first optical components 203. In an embodiment the material 105 for the first active layer 201 may be a translucent material that can be used as a core material for the desired first optical components 203, such as a semiconductor material such as silicon, germanium, silicon germanium, combinations of these, or the like, while in other embodiments the material 105 for the first active layer 201 may be a dielectric material such as silicon nitride or the like, although in other embodiments the material 105 for the first active layer 201 may be III-V materials, lithium niobate materials, or polymers. In embodiments in which the material 105 of the first active layer 201 is deposited, the material 105 for the first active layer 201 may be deposited using a method such as epitaxial growth, chemical vapor deposition, atomic layer deposition, physical vapor deposition, combinations of these, or the like. In other embodiments in which the first insulator layer 103 is formed using an implantation method, the material 105 of the first active layer 201 may initially be part of the first substrate 101 prior to the implantation process to form the first insulation layer 103. However, any suitable materials and methods of manufacture may be utilized to form the material 105 of the first active layer 201.

FIG. 2 illustrates that, once the material 105 for the first active layer 201 is ready, the first optical components 203 for the first active layer 201 are manufactured using the material 105 for the first active layer 201. In embodiments the first optical components 203 of the first active layer 201 may include such components as optical waveguides (e.g., ridge waveguides, rib waveguides, buried channel waveguides, diffused waveguides, etc.), directional couplers, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable first optical components 203 may be used.

To begin forming the first active layer 201 of the first optical components 203 from the initial material, the material 105 for the first active layer 201 may be patterned into the desired shapes for the first active layer 201 of first optical components 203. In an embodiment the material 105 for the first active layer 201 may be patterned using, e.g., one or more photolithographic masking and etching processes. However, any suitable method of patterning the material 105 for the first active layer 201 may be utilized. For some of the first optical components 203, the patterning process may be all or at least most of the manufacturing that is used to form these first optical components 203.

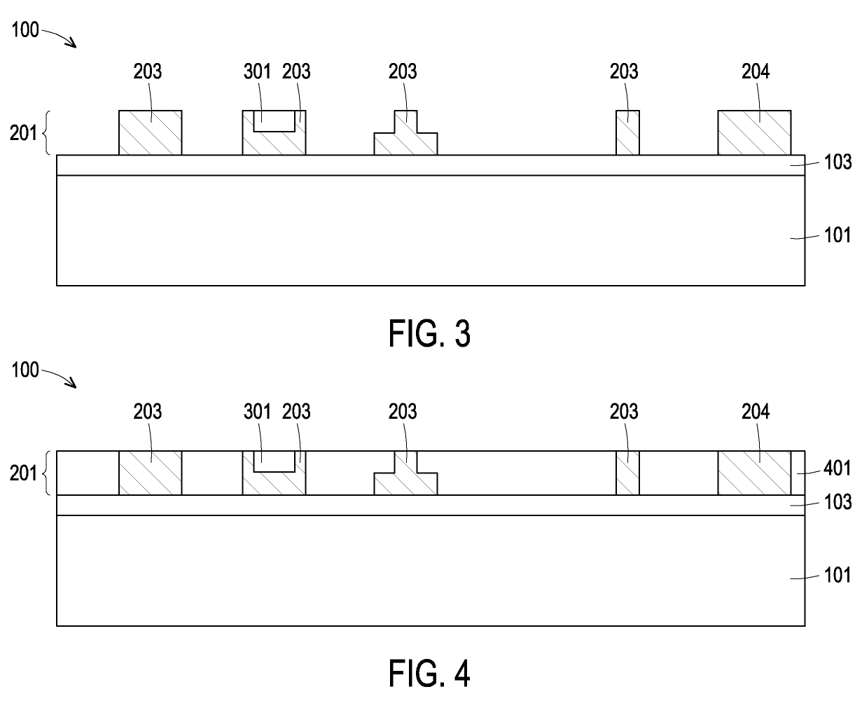

In some embodiments, a portion of the interposer 100 may be processed to provide a grating coupler 204 (as seen in FIG. 3). The portion of the interposer 100 that is processed to provide the grating coupler 204 is hereafter referred to as the grating coupler portion 205 of the interposer 100. In some embodiments, to protect the first optical components 203 during the processing used for forming the grating coupler 204, the portions of the interposer 100 that the first optical components 203 are present in is covered with a masking structure. In some embodiments, the masking structure is patterned to provide that the grating coupler portion 205 of the interposer 100 is exposed. The masking structure which protects the first optical components 203 from the processes used to form the grating coupler 204 may be a hardmask, photoresist mask or a combination of a photoresist mask and hardmask. The masking structure used to isolate the grating coupler portion 205 of the interposer may be removed following completion of the grating coupler 204.

FIG. 2A illustrates one embodiment of forming a first mask 206 to protect the first optical components 203 and expose the grating coupler portion 205 of the interposer 100. Following the formation of the first mask 206, an etch process may be used to remove any portion of the first active layer 105 and the first insulating layer 103 that may be present in the grating coupler portion 205 of the interposer 100. The etch process used at this stage of the process flow may be an anisotropic etch, such as reactive ion etching (RIE). In some embodiments, the etch process that is used to remove the first insulating layer 103 may include an etch chemistry that is selective to the first substrate 101. Following removing the first insulating layer 103, the upper surface of the first substrate 101 may be exposed.

FIG. 2B-2D illustrate one embodiment of processing the grating coupler portion 205 of interposer 100 to form a grating coupler 204 grating coupler portion 205 and a second set of gratings 212 extending in a second direction in a second region 209 of the grating coupler portion 205 (seen in FIG. 2C). During the processing of the grating coupler portion 205 that is depicted in FIGS. 2B-2D, the remaining portions of the interposer 100 including the first optical components 203 may be protected by one or more block masks and/or hard masks.

FIG. 2B illustrates an embodiment of forming a mirror layer 260 on the upper surface of the first substrate 101 that is present in the grating coupler portion 205. The mirror layer 260 may be composed of a metal containing composition material. For example, the mirror layer 260 may be composed of a metal, such as gold (Au), silver (Ag), copper (Cu), tin (Sn), aluminum (Al), tungsten (W), tantalum (Ta), platinum (Pt) and alloys thereof. In some embodiments, forming the mirror layer 260 may begin with depositing a seed layer. For example, the seed layer may comprise a copper layer. The seed layer may be deposited using processes such as sputtering, evaporation, or plasma-enhanced chemical vapor deposition (PECVD), or the like, depending upon the desired materials. The mirror layer 260 may then be plated on the seed layer. The plate metal for the mirror layer 260 may be deposited over the seed layer through a plating process such as electrical or electro-less plating. It is noted that methods and compositions for the mirror layer 260 are provided for illustrative purposes only and are not intended to limit the disclosure to only the material and methods described above. Other compositions and methods for the mirror layer 260 are also within the scope of the present disclosure, so long as the mirror layer 260 being formed is a light reflecting structure. For example, the mirror layer 260 may be formed using backside processing at a later point of the process flow, e.g., following formation of the grating structures. Further, the mirror layer 260 may provide a distributed Bragg reflector.

FIG. 2B also illustrates forming a first cladding layer 103A on the mirror layer 260. The first cladding layer 103A may be composed of an oxide containing material composition, such as silicon oxide (SiO₂). The first cladding layer 103A may be deposited using a chemical vapor deposition (CVD) process. It is noted that chemical vapor deposition (CVD) is only one example of a deposition process that is suitable for forming the first cladding layer 103A. In other examples, the first cladding layer 103A may be formed using a deposition process, such as atomic layer deposition (ALD) or physical vapor deposition (PVD).

FIG. 2B also illustrates an embodiment of forming trenches 210 in the first cladding layer 103A that are present in the grating coupler portion 205 of the interposer 100. In some embodiments, forming the trenches 210 includes forming a first etch mask 207. The first etch mask 207 exposes an entirety of the first cladding layer 103A in a first region 208 of the grating coupler portion 205. The first etch mask 207 also protects portions of the first cladding layer 103A in a second region 209 of the grating coupler portion 205 to form a plurality of trenches 210.

In some embodiments, the etch process for recessing the first cladding layer 103A in the first region 208 of the grating coupler portion 205, and for forming the trenches 210 in the second region 209 of the grating coupler portion 205 may be a directional etch, such as reactive ion etching (RIE). The trenches 210 that are formed in the first cladding layer 103A are subsequently filled with material from the subsequently formed single grating layer 211. In some embodiments, filling the trenches 210 with the material of the single grating layer 211 provides the second set of gratings 212 (not illustrated in FIG. 2B but illustrated below in FIG. 2C). In some embodiments, the trenches 210 may be patterned having a geometry with a curvature and a tapering width so that when filled with the material of the single grating layer 211 can provide a second set of gratings 212 having the geometry depicted in the top-down view illustrated in FIG. 2E.

FIG. 2C illustrates one embodiment of forming the single grating layer 211 on the first cladding layer 103A after the trenches 210 are formed. In the embodiment that is depicted in FIGS. 2B-2E, the single grating layer 211 is provided from a material layer that is deposited using a single deposition step. In some embodiments, the single grating layer 211 may be composed of a semiconductor containing material, such as a silicon containing material, e.g., silicon (Si). In other embodiments, the single grating layer 211 may be composed of a dielectric material, such as a nitride containing material, e.g., silicon nitride (Si₃N₄).

In some embodiments, the single grating layer 211 may be deposited using a chemical vapor deposition (CVD) process, in which the deposition parameters are selected to at least fill the trenches 210 with the material of the single grating layer 211. In one example, the chemical vapor deposition (CVD) process may be plasma enhanced chemical vapor deposition (PECVD). In other examples, the single grating layer 211 may be deposited using high density plasma chemical vapor deposition (HDPCVD), atomic layer deposition (ALD) or physical vapor deposition (PVD).

As noted above, a portion of the material for the single grating layer 211 fills trenches 210 that were previously formed in the portion of the first cladding layer 103A. The set of gratings formed during the step of the process is present in the second region 209 of the grating coupler portion 205 of the interposer 100, and may hereafter be referred to as the second set of gratings 212.

FIG. 2D illustrates forming another set of gratings in an upper surface of the single grating layer 211 that is present in the first region 208 of the grating coupler portion 205 of the interposer 100. The gratings that are present in the first region 208 of the grating coupler portion 205 of the interposer 100 are hereafter referred to as the first set of gratings 214. Forming the first set of gratings 214 in the upper surface of the single grating layer 211 may include forming a second etch mask (not shown) patterned to expose a portion of the single grating layer 211 in the first region 208 that is to be etched to form trenches 213. The second etch mask may be a photoresist mask that is formed using photolithography. In some embodiments, the etch process for forming the trenches 213 may be an anisotropic etch process, such as reactive ion etching (RIE). Following the etch process, the second etch mask may be removed using a chemical stripping or ashing process. The remaining portions of the single grating layer 211 between sets of trenches 213 in the upper surface of the single grating layer 211 provide the first set of gratings 214. The first set of gratings 214 may have a geometry with a curvature and a tapering width, as depicted in the top-down view illustrated in FIG. 2E.

In some embodiments, the first set of gratings 214 in the first region 208 are horizontally offset from the second set of gratings 212 in the second region 209 of the grating coupler portion 205 of the interposer 100. In some embodiments, the first set of gratings 214 have their greatest width at the end of the grating coupler 204, and taper to their narrowest width at the interface of the first set of gratings 214 and the second set of gratings 212. The width for the second set of gratings 212 begins at its widest point at the interface with the first set of gratings 214, and then tapers in width to its narrowest width at the interface to the waveguide joining portion 215 of the grating coupler.

Referring to FIG. 2D, in some embodiments, the first set of gratings 214 are present in the upper surface of the single grating layer 211, and have a height that extends in a first direction D1. The second set of gratings 212 are present in a lower surface of the single grating layer 211 and have a height that extends in a second direction D2. The first direction D1 for the first set of gratings 214 is opposite the second direction D2 for the second set of gratings. In some embodiments, the opposing first and second directions D1, D2 for first and second sets of gratings 214, 212 provide a bidirectional grating coupler structure.

The first set of gratings 214 being present in the upper surface of the single grating layer 211 are also vertically offset from the second set of gratings 212 that are present in the lower surface of the single grating layer 211. In some embodiments, the vertical offset of the first set of gratings 214 from the second set of gratings 212 can increase the coupling efficiency of the grating coupler 204. For example, by offsetting the direction and center position of the grating groove, the coupling efficiency may be increased, while reducing insertion loss and reflection loss. Additionally, the offsetting method can improve the stability and reliability of the grating coupler. In some embodiments, the vertical offsetting can also reduce the manufacturing cost and reduce the complexity of manufacturing for the grating coupler.

FIG. 2E is a top down view of the grating coupler 204 including a single grating layer having the first set of gratings 214. The first set of gratings 214 may have a geometry with a curvature and a tapering width, as depicted in the top-down view illustrated in FIG. 2E.

FIG. 2F illustrates an embodiment of a grating coupler 204, in which the height of gratings in an array of gratings, such as the first set of gratings 214 or the second set of gratings 212, can be varied. In some embodiments, varying the height of the gratings in the grating coupler can decrease loss. For example, varying the height of the gratings for the first set of gratings 214 and/or the second set of gratings 212 can decrease at least one of insertion loss and reflection loss. In some embodiments, by decreasing loss, varying the grating height for at least one of the first and second set of gratings 214, 212 can increase the coupling efficiency of the grating coupler.

FIG. 2F illustrates an embodiment of a single grating layer 211 including the first set of gratings 214 that includes an array of gratings having a varied height. In some embodiments, the height of the gratings within the array of gratings is increased from an edge grating 216 at the edge of the array to a center grating 217 at substantially a center of the array. In some embodiments, the tallest grating, e.g., the center grating 217, at the center portion of the array can provide an apex for the array of gratings.

In some embodiments, the variation in the height of the gratings can be provided through a sequence of photolithography and etch process steps, in which different etch masks may be used for different heights of the gratings. In other embodiments, the single grating layer 211 may be further processed to provide for different etch rates in different regions, which would correspond to the gratings having the different heights. For example, an ion implantation process may increase the etch rate of an implanted portion of the single grating layer 211 in comparison to portions of the single grating layer 211 that have not been implanted. In some embodiments, the implant species may change the chemistry of the implanted region, which can increase or decrease etch selectivity of the implanted regions of the single grating layer 211 relative to the non-implanted regions. In some other embodiments, the implant species can physically damage or introduce porosity into the implanted regions of the single grating layer 211, which can increase etch rate relative to the portions of the single grating layer 211 that have not been damaged by the ion implantation step. The implantation process may be used in combination with a photoresist mask to control which portions of the single grating layer 211 are implanted, and which are not implanted. It is noted that the aforementioned methods of patterning and etching for forming gratings having different heights in an array of gratings is provided for illustrative purposes only. Other etch and patterning methods may also be suitable for this stage of the process flow. For example, holographic patterning of photoresist layers is another method of masking that can be used to provide gratings having different grating heights.

FIG. 2G illustrates another embodiment of how the height of the gratings in at least one of the first set of gratings 214 and the second set of gratings 212 may be varied. In some embodiments, the height of the gratings may be varied by varying the etch depth of the trenches separating the gratings. In some embodiments, the trenches separating the gratings may be referred to as grooves 218. For example, in the embodiment depicted in FIG. 2G, the first set of gratings 214 includes an array of grooves 218 with an increasing depth from a perimeter of the array of grooves towards a center of the array of grooves. In one example, the depth of the grooves 218 at the perimeter of the array may be shallow to provide an edge grating 219 with a short height. In this example, the depth of the grooves 218 increases towards the center of the array. The center grating 220 at a central region of the array may have the greatest height, which results from grooves 218 on opposing sides of the center grating 220 having the greatest depth.

In some embodiments, the variation in the depth of the grooves 218 separating the gratings can be provided through a sequence of photolithography and etch process steps, in which different etch masks may be used for different etch depths of the grooves 218. In some embodiments, the single grating layer 211 may be further processed to provide for different etch rates in different regions, which would correspond to the grooves having the different depths. For example, an ion implantation process may increase the etch rate of an implanted portion of the single grating layer 211 in comparison to portions of the single grating layer 211 that have not been implanted. In some embodiments, the implant species may change the chemistry of the implanted region, which can increase or decrease etch selectivity of the implanted regions of the single grating layer 211 relative to the non-implanted regions. In some other embodiments, the implant species can physically damage or introduce porosity into the implanted regions of the single grating layer 211, which can increase etch rate relative to the portions of the single grating layer 211 that have not been damaged by the ion implantation step. The implantation process may be used in combination with a photoresist mask to control which portions of the single grating layer 211 are implanted, and which are not implanted.

It is noted that the aforementioned methods of patterning and etching for forming grooves 218 having different depths in an array of gratings is provided for illustrative purposes only. Other etch and patterning methods may also be suitable for this stage of the process flow. For example, holographic patterning of photoresist layers is another method of masking that can be used to provide grooves 218 having different depths.

The grating coupler designs depicted in FIG. 2D-2G may further include a second cladding layer (not shown) formed on the surface of the single grating layer 211 including the first set of gratings 214, which may be the upper surface of the single grating layer 211. In some embodiments, the second cladding layer may be composed of a cladding material such as silicon oxide, silicon nitride, germanium oxide, germanium nitride, combinations of these, or the like, formed using a deposition method such as chemical vapor deposition, atomic layer deposition, physical vapor deposition, or the like.

FIGS. 2H-2L illustrate another embodiment of processing the grating coupler portion 205 of interposer 100 to form a grating coupler atop the first substrate 101 that includes a multilayer grating structure. The multilayered grating structure includes a first grating layer 221 with a plurality of grooves, and a second grating layer 223 present on the first grating layer 221. As can be seen in FIG. 2J, the second grating layer 223 has a first set of gratings 214 on an upper surface of the second grating layer 223. The second grating layer 223 also includes a second set of gratings 212 on a lower surface of the second grating layer 223 that interfaces with the first grating layer 221. In some embodiments, the first set of gratings 214 have a height that extends in a first direction D1, and the second set of gratings 212 extend in a second direction D2. The second set of gratings 212 from the lower surface of the second grating layer 223 extend into the plurality of trenches in the first grating layer 221 (seen in FIG. 2J). During the processing of the grating coupler portion 205 that is depicted in FIG. 2H-2L, the remaining portions of the interposer 100 including the first optical components 203 may be protected by one or more block masks and/or hard masks.

FIG. 2H illustrates forming a mirror layer 260 on the exposed surface of the first substrate 101, and forming a first cladding layer 103A on the mirror layer 260. The exposed surface of the first substrate 101 in the grating coupler portion 205 of the interposer 100 that the mirror layer 260 is formed on has been described above with reference to FIG. 2A. Further, forming the mirror layer 260 has been described above with reference to FIG. 2B. Referring to FIG. 2H, the first cladding layer 103A is formed atop the mirror layer 260. The first cladding layer 103A may be an oxide, such as silicon oxide, and may be deposited using a chemical vapor deposition (CVD) method. Other deposition methods suitable for forming the first cladding layer 103A may include atomic layer deposition (ALD) and physical vapor deposition (PVD). In some embodiments, a planarization process, such as chemical mechanical planarization may be applied to the upper surface of the first cladding layer 103A.

FIG. 2H also illustrates forming a first grating layer 221 on the first cladding layer 103A. In some embodiments, the first grating layer 221 may be composed of a semiconductor containing material, such as silicon (Si). In some embodiments, the first grating layer 221 may be composed of a nitride containing material, such as silicon nitride (Si₃N₄). In some embodiments, the first grating layer 221 is patterned and etched to provide a plurality of trenches 222 that are etched into the upper surface of the first grating layer 221.

In some embodiments, the plurality of trenches 222 are formed into the portion of the first grating layer 221 that is present in the second region 209 of the grating coupler portion 205 of the interposer 100. In some embodiments, a block mask, e.g., a photoresist mask or hardmask, may be formed to expose the second region 209 of the grating coupler portion 205, while protecting the first region 208 of the grating coupler portion 205. An etch process, such as reactive ion etching (RIE), in combination with the block mask, may then be used to form the plurality of trenches 222.

The plurality of trenches 222 are filled with a subsequently deposited material for the second grating layer 223 (as seen in FIG. 2I). Filling the plurality of trenches 222 in the first grating layer 221 will provide the second set of gratings 212 in the second region 209 of the grating coupler portion 205 of the interposer 100. Therefore, in some embodiments, the plurality of trenches 222 may be patterned having a geometry with a curvature and a tapering width so that when filled with the material of the second grating layer 223 can provide the second set of gratings 212 having the geometry depicted in the top-down view illustrated in FIG. 2K.

Following etch processing to form the plurality of trenches 222, at least the portion of the block mask that was patterned to provide the plurality of trenches 222 may be removed. However, mask structures may remain or be formed to protect the portions of the interposer 100 outside the grating coupler portion 205 of the interposer 100 while forming the multilayered grating structure.

FIG. 2I illustrates an embodiment of depositing a material layer on the first grating layer 221 to form a second grating layer 223. In some embodiments, the second grating layer 223 may be composed of a semiconductor containing material, such as a silicon containing material, e.g., silicon. In some embodiments, the second grating layer 223 may be composed of a dielectric material, such as a nitride containing material, e.g., silicon nitride. The second grating layer 223 may be deposited using a chemical vapor deposition (CVD) process, in which the deposition parameters are selected to at least fill the trenches 222. In one example, the chemical vapor deposition (CVD) process may be plasma enhanced chemical vapor deposition (PECVD). The material of the second grating layer 223 that fills the trenches 222 provides the second set of gratings 212 that are present in the second region 209 of the grating coupler portion 205 of the interposer 100.

FIG. 2J illustrates forming another set of gratings in an upper surface of the second grating layer 223, which is present in the first region 208 of the grating coupler portion 205 of the interposer 100. The gratings formed in the upper surface of the second grating layer 223 in the first region 208 of the grating coupler portion 205 may be referred to as the first set of gratings 214. Forming the first set of gratings 214 in the upper surface of the second grating layer 223 may include forming an etch mask (not shown) in the first region 208 that is patterned to expose portions of the second grating layer 223 to be etched to form trenches 224. The etch mask may be a photoresist mask that is formed using photolithography. The trenches 224 may be formed using an etch process. For example, the etch process for forming the trenches 224 may be an anisotropic etch process, such as reactive ion etching (RIE). Following the etch process, the etch mask may be removed using a chemical stripping process. The first set of gratings 214 may have a geometry with a curvature and a tapering width as depicted in the top-down view illustrated in FIG. 2K.

Referring to FIGS. 2J and 2K, in some embodiments, a portion of the first set of gratings 214 in the first region 208 and the second set of gratings 212 in the second region 209 may overlap at an interface of the first and second regions 208, 209. In some embodiments, at least a first edge grating of the first set of gratings and at least a second edge grating of the second set of gratings horizontally overlap at a substantially middle portion of the grating coupler. The overlapping gratings 216 from the first set of gratings 214 and the second set of gratings 212 can combine the advantages of broadband grating with high coupling efficiency gratings.

FIG. 2K illustrates a top down view of the multilayered grating coupler structure that is described being formed with reference to FIGS. 2H-2J. The first set of gratings 214 in the first region 208 are horizontally offset from the second set of gratings 212 in the second region 209 of the grating coupler portion 205 of the interposer 100. In some embodiments, first set of gratings 214 have their greatest width at the end of the grating coupler 204, and taper to their narrowest width at the interface of the first set of gratings 214 and the second set of gratings 212. The width for the second set of gratings 212 begins at its widest point at the interface with the first set of gratings 214, and then tapers in width to its narrowest width at the interface to the waveguide joining portion 215.

Referring to FIG. 2J, in some embodiments, the multilayered grating coupler structure includes a first set of gratings 214 that are present in the upper surface of the second grating layer 223, and have a height that extends in a first direction D1. The second set of gratings 212 are present in a lower surface of the second grating layer 223 and have a height that extends in a second direction D2. The second set of gratings 212 from the second grating layer 223 extend into trenches formed in the first grating layer 221. The first direction D1 for the first set of gratings 214 is opposite the second direction D2 for the second set of gratings 212. In some embodiments, the opposing first and second directions D1, D2 for first and second sets of gratings 214, 212 provide a bidirectional multilayered grating coupler structure. The first set of gratings 214 being present in the upper surface of the second grating layer 223 are also vertically offset from the second set of gratings 212 that are present in the lower surface of the second grating layer 223. In some embodiments, the vertical offset of the first set of gratings 214 from the second set of gratings 212 can improve the coupling efficiency of the grating coupler. For example, by offsetting the direction and center position of the grating groove, the coupling efficiency may be increased, while reducing insertion loss and reflection loss.

In some embodiments, a multilayered configuration for a grating coupling structure, as depicted in FIGS. 2H-2K, combined with the overlapping grating 216 in the middle of the array can effectively combine broadband gratings with high coupling efficiency gratings. A high coupling efficiency grating includes gratings that are separated by lesser spacing between adjacent gratings than broadband gratings.

In some embodiments, the multilayered grating coupler can reduce energy loss and can improve optical coupling efficiency. In some embodiments, the multilayered grating coupler can enhance bandwidth performance. The multilayered grating coupler can be suitable for use with different wavelengths of light sources. Additionally, the multilayered grating coupler can achieve higher optical coupling efficiency and wider bandwidth, while also achieving high wavelength selectivity and lower polarization dependence.

FIG. 2L illustrates one embodiment of a multilayered grating coupler structure including a low loss design. In the embodiment depicted in FIG. 2L, the grating structure is a multilayered structure, as described with reference to FIG. 2H-2K. However, in the embodiment depicted in FIG. 2L, the grating height for the array of gratings that provide the first set of gratings 214 and the second set of gratings 212 have been varied similar to how the grating height was varied in the embodiment described above with reference to FIG. 2G. By providing different heights, more optical energy can be coupled in, as well as a wider range of different wavelengths of light.

Referring to FIG. 2L, in some embodiments, the height of the gratings for the first set of gratings 214 may be varied by varying the etch depth of the trenches 224 separating the gratings that are formed into the upper surface of the second grating layer 223. In some embodiments, the trenches 224 separating the gratings may be referred to as grooves. For example, in the embodiment depicted in FIG. 2G, the first set of gratings 214 includes an array of grooves with an increasing depth from a perimeter of the array of grooves towards a center of the array of grooves. In one example, the depth of the grooves at the perimeter of the array may be shallow to provide an edge grating 219 with a short height. In this example, the depth of the grooves increases towards the center of the array. The center grating 220 at a central region of the array may have the greatest height, which results from grooves on opposing sides of the center grating 220 having the greatest depth.

In some embodiments, the variation in the depth of the trenches 224/grooves separating the gratings can be provided through a sequence of photolithography and etch process steps, in which different etch masks may be used for different etch depths of the grooves of the upper surface of the second grating layer 223. In some embodiments, the second grating layer 223 may be further processed to provide for different etch rates in different regions, which would correspond to the grooves having the different depths. For example, an ion implantation process may increase the etch rate of an implanted portion of the second grating layer 223 in comparison to portions of the second grating layer 223 that have not been implanted. In some embodiments, the implant species may change the chemistry of the implanted region, which can increase or decrease etch selectivity of the implanted regions of the second grating layer 223 relative to the non-implanted regions. In some other embodiments, the implant species can physically damage or introduce porosity into the implanted regions of the second grating layer 223, which can increase etch rate relative to the portions of the second grating layer 223 that have not been damaged by the ion implantation step. The implantation process may be used in combination with a photoresist mask to control which portions of the second grating layer 223 are implanted, and which are not implanted.

For example, in some embodiments, the height of the gratings for the second set of gratings 212 may be varied by varying the etch depth of the trenches 222 formed into the upper surface of the first grating layer 221. The second set of gratings 212 extend from a lower surface of the second grating layer 223 and fill the trenches 222 that are formed in the upper surface of the first grating layer 221. For example, in the embodiment depicted in FIG. 2L, the second set of gratings 212 includes an array of gratings having an increasing height from a perimeter of the array of gratings towards a center of the array of gratings. In one example, the height of the gratings at the perimeter of the array may be shallow to provide an edge grating 219 with a short height. In this example, the height of the gratings increases towards the center of the array. The center grating 220 at the center of the array may have the greatest height for the array that provides the second set of gratings 212.

In some embodiments, the variation in the depth of the trenches 222 can be provided through a sequence of photolithography and etch process steps, in which different etch masks may be used for different etch depths of the trenches 222 formed in the upper surface of the first grating layer 221. In some embodiments, the first grating layer 221 may be further processed to provide for different etch rates in different regions, which would correspond to the trenches 222 having the different depths. For example, an ion implantation process may increase the etch rate of an implanted portion of the first grating layer 221 in comparison to portions of the first grating layer 221 that have not been implanted. In some embodiments, the implant species may change the chemistry of the implanted region, which can increase or decrease etch selectivity of the implanted regions of the first grating layer 221 relative to the non-implanted regions. In some other embodiments, the implant species can physically damage or introduce porosity into the implanted regions of the first grating layer 221, which can increase etch rate relative to the portions of the first grating layer 221 that have not been damaged by the ion implantation step. The implantation process may be used in combination with a photoresist mask to control which portions of the first grating layer 221 are implanted, and which are not implanted.

It is noted that the aforementioned methods for providing gratings having varying heights are provided for illustrative reasons, and are not intended to be limited thereto. Other etch and patterning methods may also be suitable for this stage of the process flow. For example, holographic patterning of photoresist layers is another method of masking that can be used to provide gratings having different trench depths.

The architecture depicted in FIG. 2L is suitable for light sources with different wavelengths. In some embodiments, the architecture for the grating structure of the grating coupler depicted in FIG. 2L is a low loss design. The gratings, i.e., diffraction gratings, for the embodiment depicted in FIG. 2L can be designed for different wavelengths. For example, the height of the gratings and the spacing separating adjacent gratings can be modified to be compatible with different wavelengths of light. In some embodiments, the grating structure can be used with different wavelengths by providing the first set of gratings 214 and the second set gratings 212 with arrays of gratings having a varying grating height with an apex at the center of the array. The overlapping portion can be defined as the apex, allowing the overall grating structure to have a wide range of wavelengths.

FIG. 2M illustrates another embodiment of the present disclosure. The architecture depicted in FIG. 2M is similar to the embodiment described above with the reference to FIG. 2L. The architecture depicted in FIG. 2M further introduces a third set of gratings 225. The third set of gratings 225 may be a set of gratings having a broadband design that may be used in combination with the first and second sets of gratings 214, 212 that provide for low loss coupling, which were described above with reference to FIG. 2L. The third set of gratings may be referred to as a set of broadband gratings, and are present at an interface of the first grating layer 221 and the first cladding layer 103A.

In some embodiments, gratings may be provided with different periods, e.g., the gratings can have different spacing that is separating adjacent gratings. The gratings formed with different periods can be used with ultra-wide bandwidths, e.g., bandwidths greater than 100 nm, and higher wavelength selectivity. In some embodiments, a third set of gratings 225 may be formed at the interface of the first grating layer 221 and the first cladding layer 103A. In some embodiments, to provide the third set of gratings for coupling with broad band light waves, the first cladding layer 103A may be patterned and etched to provide trenches 226 before forming the first grating layer 221. The trenches 226 are subsequently filled with the material of the first grating layer 221 to provide the gratings for the third set of gratings 225. Therefore, the trenches 226 should be patterned and etched in the geometry of a grating, which can have a curvature. Further, the plurality of gratings for the third set of gratings 225 may be arranged with a tapering width having its narrowest portion adjacent to a wave guide. To provide for coupling with broad bands of light, the trenches 226 for providing the third set of gratings 225 may be separated by a greater width than the trenches that define the first and second sets of gratings 214, 212.

In some embodiments, forming the trenches 226 in the first cladding layer 103A includes forming an etch mask (not shown). The etch mask is patterned so that a subsequent etch process will recess the exposed portions of the first cladding layer 103A to form the trenches 226. In some embodiments, the etch process for forming the trenches 226 may be a directional etch process, such as reactive ion etching (RIE). The trenches 226 that are formed in the first cladding layer 103A are subsequently filled with material from the subsequently formed first grating layer 221 to provide the third set of gratings 225, which can be configured as broadband gratings. Therefore, in some examples, the trenches 226 are patterned and etched to provide different periods. In some examples, the different periods can be provided by different spacing for the dimensions separating adjacent trenches 226 in order to achieve ultra-wide bandwidth and higher wavelength selectivity for the gratings formed therein. For example, the spacing separating the adjacent gratings in the broadband configured third set of gratings 225 may range from 20 nm to 1000 nm.

Following etching of the trenches 226, the first grating layer 221 is deposited, in which at least a portion of the material for the first grating layer 221 fills the trenches 226. In some embodiments, the first grating layer 221 may be composed of a semiconductor containing material, such as a silicon containing material, e.g., silicon, or the first grating layer 221 may be composed of a dielectric material, such as a nitride containing material, e.g., silicon nitride. The first grating layer 221 may be deposited using a chemical vapor deposition (CVD) process, in which the deposition parameters are selected to at least fill the trenches 226 with the material of the first grating layer 221. In one example, the chemical vapor deposition (CVD) process may be plasma enhanced chemical vapor deposition (PECVD).

By filling the trenches 226, the first grating layer 221 forms a third set of gratings 225, e.g., a set of broadband gratings, with a direction D3 extending into the first cladding layer 103A. The gratings for the third set of broadband gratings 225 are present in both the first region 208 and the second region 209 of the grating coupler portion 205 of the interposer 100.

The multilayer gratings structure depicted in FIG. 2M further includes a second grating layer 223, a first set of gratings 214 and a second set of gratings 212. The first set of gratings 214 and the second set of gratings 212 may be configured to provide a low loss grating design to work in combination with the third set of gratings 225 configured as a broadband design. Further details on the composition, geometry and methods of forming the second grating layer 223, the first set of gratings 214, and the second set of gratings 212 have been provided above with reference to FIGS. 2I-2L.

In some embodiments, the multilayered grating structure depicted in FIG. 2M including the third set of gratings 225, the first set of gratings 214 and the second set of gratings 212 can provide diffraction gratings for different wavelengths and/or diffraction gratings having different periods to achieve ultra-wide bandwidth (e.g., bandwidths greater than 100 nm), and higher wavelength selectivity.

FIG. 2N depicts one embodiment of a grating coupler including three sets of gratings that have been configured for coupling with TM mode and TE mode light having broadband wavelengths. FIG. 2N illustrates an embodiment of how the grating period for the first set of gratings 214, the second set of gratings 212 and the third set of gratings 225 may be changed to be compatible with different polarizations. The grating structures depicted in FIG. 2N is similar to the grating structures that have been described above with reference to FIG. 2M. However, the gratings of the grating coupler structure depicted in FIG. 2N includes gratings configured to be compatible with light sources with different polarizations. For example, by changing the grating period, e.g., changing the spacing separating the adjacent gratings, the grating structures may be suitable for coupling different light wavelengths. Additionally, by combining different layers having different grating parameters, a grating coupler can be provided that can simultaneously couple transverse electric (TE) mode and transverse magnetic (TM) mode light into the adjacent waveguide, which results in lower polarization dependence for the grating coupler.

TE mode light is transverse electric waves, also sometimes called H waves, characterized by the electric vector (E) being always perpendicular to the direction of propagation. TM mode light is transverse magnetic waves, which may also be referred to as E waves. Transverse magnetic waves are characterized by the fact that the magnetic vector (H vector) is always perpendicular to the direction of propagation.

FIG. 2N illustrates one embodiment of a grating coupler 204 that is suitable for coupling with TE/TM light, as well as broadband light waves. The grating coupler depicted in FIG. 2N includes a first set of gratings 214 extending in a first direction D1, and a second set of gratings 212 extending in a second direction D2. The first and second gratings 214, 212 are present on the upper and lower surfaces of a second grating layer 223, and are therefore vertically offset from one another. The first set of gratings 214 includes an array of gratings having a varied height, and is suitable for coupling with both TE mode and TM mode of light in the C band and O band wavelengths. The C band wavelength may range from 1420 nm to 1620 nm. The O band wavelengths may range from 1260 nm to 1360 nm.

The grating coupler 204 depicted in FIG. 2N also includes a third set of gratings 225 that are configured to couple with a broad band of light. The third set of gratings 225 that is present extending from the lower surface of the first grating layer 221 is suitable for coupling with both TE mode and TM mode of light in wavelengths that are +/- 50 nm for C band and O band wavelengths. The spacing P1 separating the gratings for the third set of gratings 225 for the grating coupler 204 depicted in FIG. 2N may range from 20 nm to 1000 nm.

FIG. 2O depicts another embodiment of a grating coupler 204 including three sets of gratings that have been configured for coupling with TM mode and TE mode light having C/O wavelengths. FIG. 2O illustrates another embodiment of how the grating period for the first set of gratings 214, the second set of gratings 212 and the third set of gratings 225 may be changed to be compatible with different polarizations.

The grating coupler depicted in FIG. 2O includes a first set of gratings 214 extending in a first direction D1, and a second set of gratings 212 extending in a second direction D2. The first and second gratings 214, 212 are present on the upper and lower surfaces of a second grating layer 223, and are therefore vertically offset from one another. The first set of gratings 214 includes an array of gratings having a varied depth for the trenches separating the gratings, and is suitable for coupling with the TE mode of light in the C band and O band wavelengths.

The grating coupler depicted in FIG. 2O also includes a third set of gratings 225 that is present extending from the lower surface of the first grating layer 221 that is suitable for coupling with the TM mode of light in the C band and O band wavelengths. The spacing P2 separating the gratings for the third set of gratings 225 for the grating coupler depicted in FIG. 2O may range from 20 nm to 1000 nm.

FIGS. 3-9 illustrate formation of an optical package integrating the grating couplers as described above with reference to FIGS. 2A-2O. Each of the embodiments depicted in FIGS. 2A-2O may be integrated into the optical package described with reference to FIGS. 3-9. For simplicity, the different embodiments for the grating couplers depicted in FIGS. 2A-2O may collectively be depicted by the structure having reference number 204 in FIGS. 3-9. In some embodiments, prior to processing to integrate the grating coupler 204 into an optical package, any masking structures, e.g., hard masks and/or photoresist masks, used to isolate the grating coupler portion 205 of the interposer 100 during forming the grating coupler 204 may be removed.

FIG. 3 illustrates that, for those components that utilize further manufacturing processes, such as Mach-Zehnder silicon-photonic switches that utilize resistive heating elements, additional processing may be performed either before or after the patterning of the material for the first active layer 201 for forming the first optical components and/or either before or after forming the grating coupler 204. For example, implantation processes, additional deposition and patterning processes for different materials (e.g., resistive heating elements, III-V materials for converters), combinations of all of these processes, or the like, can be utilized to help further the manufacturing of the various desired first optical components 203. In a particular embodiment, and as specifically illustrated in FIG. 3, in some embodiments an epitaxial deposition of a semiconductor material 301 such as germanium (used, e.g., for electricity/optics signal modulation and transversion) may be performed on a patterned portion of the material 105 of the first active layer 201. In such an embodiment the semiconductor material 301 may be epitaxially grown in order to help manufacture, e.g., a photodiode for an optical-to-electrical converter. All such manufacturing processes and all suitable first optical components 203 may be manufactured, and all such combinations are fully intended to be included within the scope of the embodiments.

FIG. 4 illustrates that, once the grating coupler 204 and the first optical components 203 have been formed, a second insulator layer 401 may be deposited to cover the grating coupler 204 and the first optical components 203. The second insulator layer 401 may provide additional cladding material. In an embodiment the second insulator layer 401 may be a dielectric layer that separates the individual components of the first active layer 201 from each other and from the overlying structures and can additionally serve as another portion of cladding material that surrounds the first optical components 203 and the grating coupler 204. In an embodiment the second insulator layer 401 may be silicon oxide, silicon nitride, germanium oxide, germanium nitride, combinations of these, or the like, formed using a deposition method such as chemical vapor deposition, atomic layer deposition, physical vapor deposition, combinations of these, or the like. Once the material of the second insulator layer 401 has been deposited, the material may be planarized using, e.g., a chemical mechanical polishing process in order to either planarize a top surface of the second insulator layer 401 (in embodiments in which the second insulator layer 401 is intended to fully cover the first optical components 203 and the grating coupler 204) or else planarize the second insulator layer 401 with top surfaces of the first optical components 203 and the grating coupler 204. However, any suitable material and method of manufacture may be used.

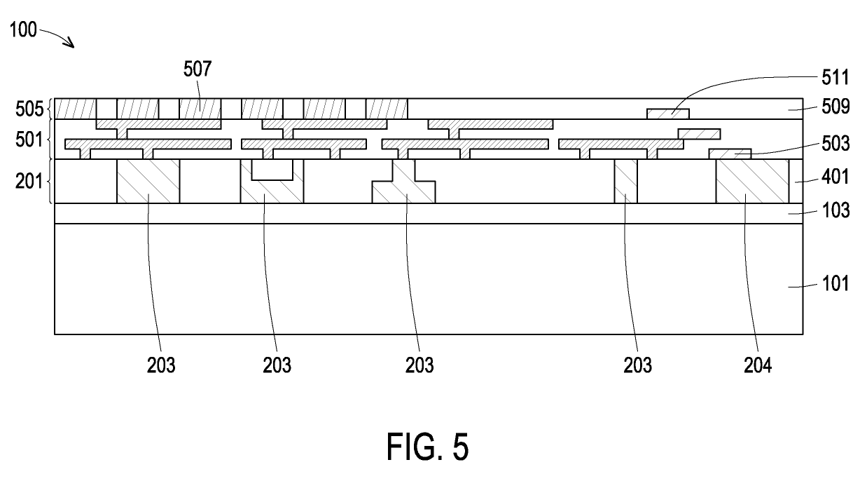

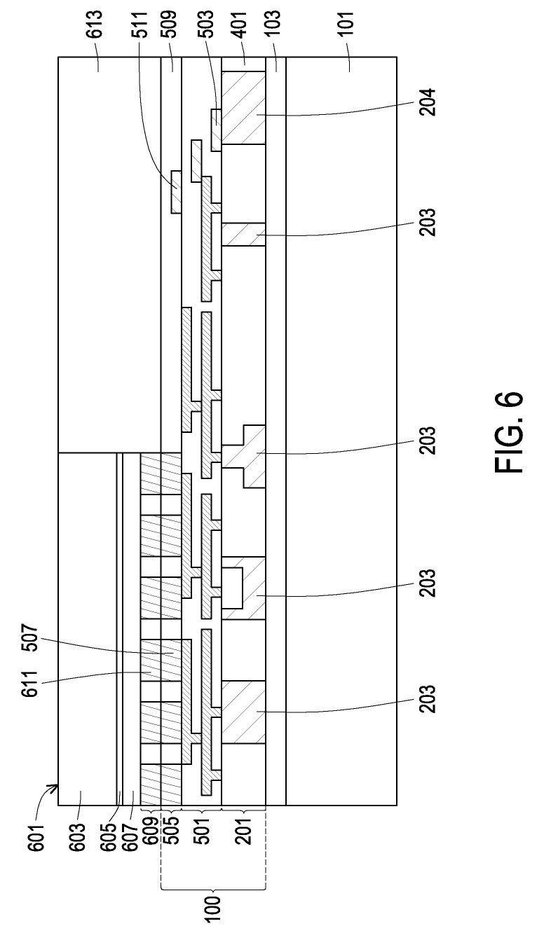

FIG. 5 illustrates that, once the first optical components 203 and the grating coupler 204 have been manufactured and the second insulator layer 401 has been formed, first metallization layers 501 are formed in order to electrically connect the first active layer 201 of first optical components 203 and the grating coupler 204 to control circuitry, to each other, and to subsequently attached devices (not illustrated in FIG. 5 but illustrated and described further below with respect to FIG. 6). In an embodiment the first metallization layers 501 are formed of alternating layers of dielectric and conductive material and may be formed through any suitable processes (such as deposition, damascene, dual damascene, etc.). In particular embodiments there may be multiple layers of metallization used to interconnect the various first optical components 203, as well as the grating coupler 204, but the precise number of first metallization layers 501 is dependent upon the design of the optical interposer 100.

Additionally, during the manufacture of the first metallization layers 501, one or more second optical components 503 may be formed as part of the first metallization layers 501. In some embodiments the second optical components 503 of the first metallization layers 501 may include such components as couplers (e.g., edge couplers, grating couplers, etc.) for connection to outside signals, optical waveguides (e.g., ridge waveguides, rib waveguides, buried channel waveguides, diffused waveguides, etc.), optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more second optical components 503.

In an embodiment the one or more second optical components 503 may be formed by initially depositing a material for the one or more second optical components 503. In an embodiment the material for the one or more second optical components 503 may be a dielectric material such as silicon nitride, silicon oxide, combinations of these, or the like, or a semiconductor material such as silicon, deposited using a deposition method such as chemical vapor deposition, atomic layer deposition, physical vapor deposition, combinations of these, or the like. However, any suitable material and any suitable method of deposition may be utilized.

Once the material for the one or more second optical components 503 has been deposited or otherwise formed, the material may be patterned into the desired shapes for the one or more second optical components 503. In an embodiment the material of the one or more second optical components 503 may be patterned using, e.g., one or more photolithographic masking and etching processes. However, any suitable method of patterning the material for the one or more second optical components 503 may be utilized.

For some of the one or more second optical components 503, such as waveguides or edge couplers, the patterning process may be all or at least most manufacturing that is used to form these components. Additionally, for those components that utilize further manufacturing processes, such as Mach-Zehnder silicon-photonic switches that utilize resistive heating elements, additional processing may be performed either before or after the patterning of the material for the one or more second optical components 503. For example, implantation processes, additional deposition and patterning processes for different materials, combinations of all of these processes, or the like, can be utilized to help further the manufacturing of the various desired one or more second optical components 503. All such manufacturing processes and all suitable one or more second optical components 503 may be manufactured, and all such combinations are fully intended to be included within the scope of the embodiments.

Once the one or more second optical components 503 of the first metallization layers 501 have been manufactured, a first bonding layer 505 is formed over the first metallization layers 501. In an embodiment, the first bonding layer 505 may be used for a dielectric-to-dielectric and metal-to-metal bond. In accordance with some embodiments, the first bonding layer 505 is formed of a first dielectric material 509 such as silicon oxide, silicon nitride, or the like. The first dielectric material 509 may be deposited using any suitable method, such as CVD, high-density plasma chemical vapor deposition (HDPCVD), PVD, atomic layer deposition (ALD), or the like. However, any suitable materials and deposition processes may be utilized.

Once the first dielectric material 509 has been formed, first openings in the first dielectric material 509 are formed to expose conductive portions of the underlying layers in preparation to form first bond pads 507 within the first bonding layer 505. Once the first openings have been formed within the first dielectric material 509, the first openings may be filled with a seed layer and a plate metal to form the first bond pads 507 within the first dielectric material 509. The seed layer may be blanket deposited over top surfaces of the first dielectric material 509 and the exposed conductive portions of the underlying layers and sidewalls of the openings and the second openings. The seed layer may comprise a copper layer. The seed layer may be deposited using processes such as sputtering, evaporation, or plasma-enhanced chemical vapor deposition (PECVD), or the like, depending upon the desired materials. The plate metal may be deposited over the seed layer through a plating process such as electrical or electro-less plating. The plate metal may comprise copper, a copper alloy, or the like. The plate metal may be a fill material. A barrier layer (not separately illustrated) may be blanket deposited over top surfaces of the first dielectric material 509 and sidewalls of the openings and the second openings before the seed layer. The barrier layer may comprise titanium, titanium nitride, tantalum, tantalum nitride, or the like.

Following the filling of the first openings, a planarization process, such as a CMP, is performed to remove excess portions of the seed layer and the plate metal, forming the first bond pads 507 within the first bonding layer 505. In some embodiments a bond pad via (not separately illustrated) may also be utilized to connect the first bond pads 507 with underlying conductive portions and, through the underlying conductive portions, connect the first bond pads 507 with the first metallization layers 501.

Additionally, the first bonding layer 505 may also include one or more third optical components 511 incorporated within the first bonding layer 505. In such an embodiment, prior to the deposition of the first dielectric material 509, the one or more third optical components 511 may be manufactured using similar methods and similar materials as the one or more second optical components 503 (described above), such as by being waveguides and other structures formed at least in part through a deposition and patterning process. However, any suitable structures, materials and any suitable methods of manufacture may be utilized.

FIG. 6 illustrates a bonding of a first semiconductor device 601 to the first bonding layer 505 of the optical interposer 100. In some embodiments, the first semiconductor device 601 is an electronic integrated circuit (EIC – e.g., a device without optical devices) and may have a semiconductor substrate 603, a layer of active devices 605, an overlying interconnect structure 607, a second bonding layer 609, and associated third bond pads 611. In an embodiment the semiconductor substrate 603 may be similar to the first substrate 101 (e.g., a semiconductor material such as silicon or silicon germanium), the active devices 605 may be transistors, capacitors, resistors, and the like formed over the semiconductor substrate 603, the interconnect structure 607 may be similar to the first metallization layers 501 (without optical components), the second bonding layer 609 may be similar to the first bonding layer 505, and the third bond pads 611 may be similar to the first bond pads 507. However, any suitable devices may be utilized.

In an embodiment the first semiconductor device 601 may be configured to work with the optical interposer 100 for a desired functionality. In some embodiments the first semiconductor device 601 may be a high bandwidth memory (HBM) module, an xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

In an embodiment the first semiconductor device 601 and the first bonding layer 505 may be bonded using a dielectric-to-dielectric and metal-to-metal bonding process. In a particular embodiment which utilizes a dielectric-to-dielectric and metal-to-metal bonding process, the process may be initiated by activating the surfaces of the second bonding layer 609 and the surfaces of the first bonding layer 505. Activating the top surfaces of the first bonding layer 505 and the second bonding layer 609 may comprise a dry treatment, a wet treatment, a plasma treatment, exposure to an inert gas plasma, exposure to H2, exposure to N2, exposure to O2, combinations thereof, or the like, as examples. In embodiments where a wet treatment is used, an RCA cleaning may be used, for example. In another embodiment, the activation process may comprise other types of treatments. The activation process assists in the bonding of the first bonding layer 505 and the second bonding layer 609.

After the activation process the optical interposer 100 and the first semiconductor device 601 may be cleaned using, e.g., a chemical rinse, and then the first semiconductor device 601 is aligned and placed into physical contact with the optical interposer 100. The optical interposer 100 and the first semiconductor device 601 are then subjected to thermal treatment and contact pressure to bond the optical interposer 100 and the laser die. For example, the optical interposer 100 and the first semiconductor device 601 may be subjected to a pressure of about 200 kPa or less, and a temperature between about 25°C and about 250°C to fuse the optical interposer 100 and the first semiconductor device 601. The optical interposer 100 and the first semiconductor device 601 may then be subjected to a temperature at or above the eutectic point for material of the first bond pads 507 and the third bond pads 611, e.g., between about 150°C and about 650°C, to fuse the metal. In this manner, the optical interposer 100 and the first semiconductor device 601 forms a dielectric-to-dielectric and metal-to-metal bonded device. In some embodiments, the bonded dies are subsequently baked, annealed, pressed, or otherwise treated to strengthen or finalize the bond.

Additionally, while specific processes have been described to initiate and strengthen the bonds, these descriptions are intended to be illustrative and are not intended to be limiting upon the embodiments. Rather, any suitable combination of baking, annealing, pressing, or combination of processes may be utilized. All such processes are fully intended to be included within the scope of the embodiments.

FIG. 6 additionally illustrates that, once the first semiconductor device 601 has been bonded, a second gap-fill material 613 is deposited in order to fill the space around the first semiconductor device 601 and provide additional support. In an embodiment the second gap-fill material 613 may be a material such as silicon oxide, silicon nitride, silicon oxynitride, combinations of these, or the like, deposited to fill and overfill the spaces around the first semiconductor device 601. However, any suitable material and method of deposition may be utilized.

Once the second gap-fill material 613 has been deposited, the second gap-fill material 613 may be planarized in order to expose the first semiconductor device 601. In an embodiment the planarization process may be a chemical mechanical planarization process, a grinding process, or the like. However, any suitable planarization process may be utilized.

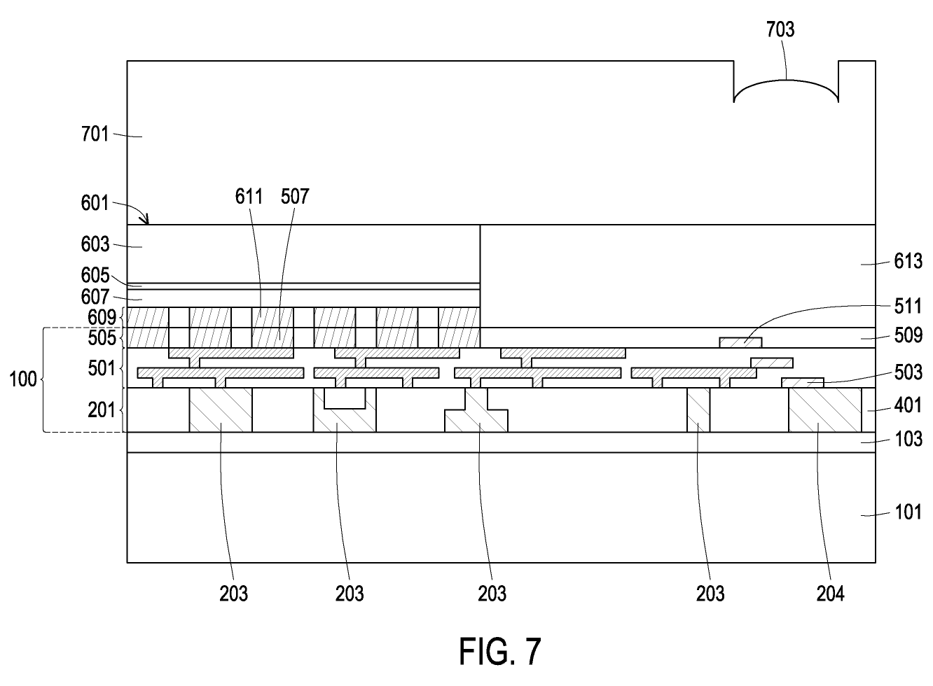

FIG. 7 illustrates an attachment of a support substrate 701 to the first semiconductor device 601 and the second gap-fill material 613. In an embodiment the support substrate 701 may be a support material that is transparent to the wavelength of light that is desired to be used, such as silicon, and may be attached using, e.g., an adhesive (not separately illustrated in FIG. 7). However, in other embodiments the support substrate 701 may be bonded to the first semiconductor device 601 and the second gap-fill material 613 using, e.g., a bonding process. Any suitable method of attaching the support substrate 701 may be used.

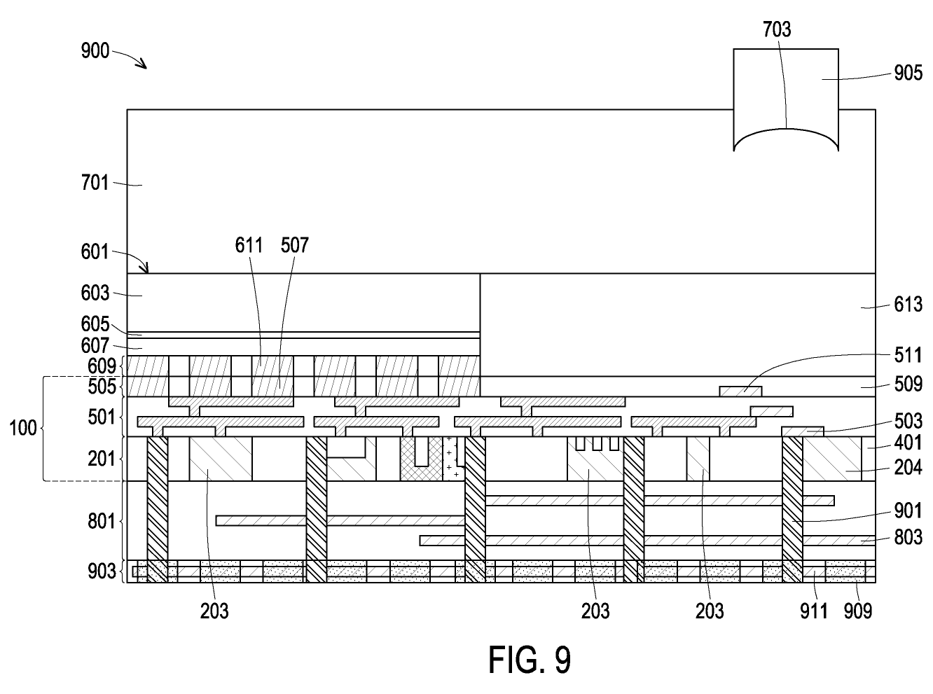

FIG. 7 additionally illustrates the support substrate 701 comprises a coupling lens 703 positioned to facilitate movement from an optical fiber 905 (not illustrated in FIG. 7 but illustrated and described further below with respect to FIG. 9) to the grating coupler 204, the second optical components 503 of the first metallization layers 501, or the third optical components 511. In an embodiment the coupling lens 703 may be formed by shaping the material of the support substrate (e.g., silicon) using masking and etching processes. However, any suitable process may be utilized.

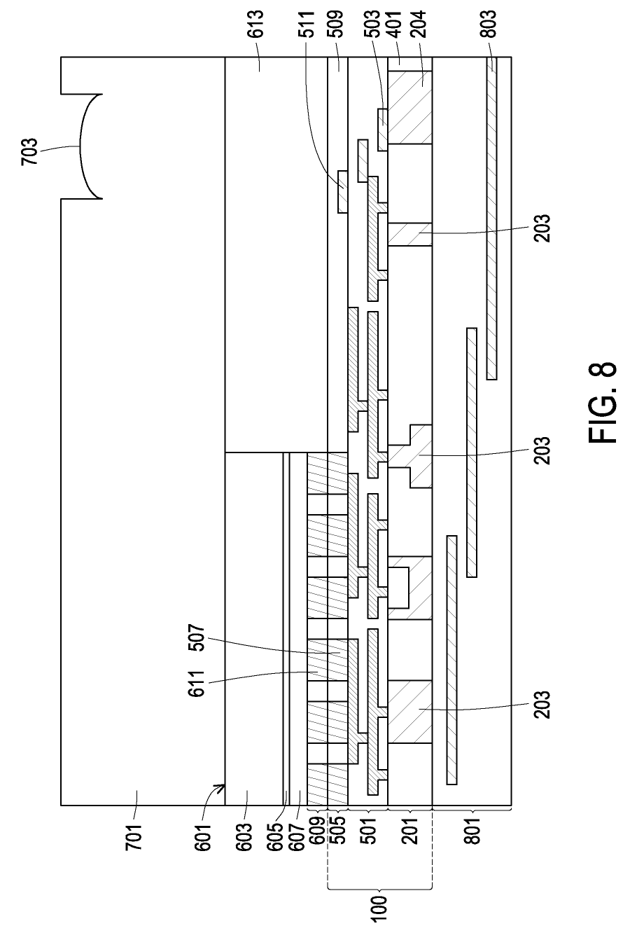

FIG. 8 illustrates a removal of the first substrate 101 and, optionally, the first insulator layer 103, thereby exposing the first active layer 201 of first optical components 203 and the grating coupler 204. In an embodiment the first substrate 101 and the first insulator layer 103 may be removed using a planarization process, such as a chemical mechanical polishing process, a grinding process, one or more etching processes, combinations of these, or the like. However, any suitable method may be used in order to remove the first substrate 101 and/or the first insulator layer 103.

Once the first substrate 101 and the first insulator layer 103 have been removed, a second active layer 801 of fourth optical components 803 may be formed on a back side of the first active layer 201. In an embodiment the second active layer 801 of fourth optical components 803 may be formed using similar materials and similar processes as the second optical components 503 of the first metallization layers 501 (described above with respect to FIG. 5). For example, the second active layer 801 of fourth optical components 803 may be formed of alternating layers of a cladding material such as silicon oxide and core material such as silicon nitride formed using deposition and patterning processes in order to form optical components such as waveguides and the like.

FIG. 9 illustrates formation of first through device vias (TDVs) 901, formation of a third bonding layer 903, and placement of an optical fiber 905 to form a first optical package 900. In an embodiment the first through device vias 901 extend through the second active layer 801 and the first active layer 201 so as to provide a quick passage of power, data, and ground through the optical interposer 100. In an embodiment the first through device vias 901 may be formed by initially forming through device via openings into the optical interposer 100. The through device via openings may be formed by applying and developing a suitable photoresist (not shown), and removing portions of the second active layer 801 and the optical interposer 100 that are exposed.

Once the through device via openings have been formed within the optical interposer 100, the through device via openings may be lined with a liner. The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition or a thermal process, may also be used.

Once the liner has been formed along the sidewalls and bottom of the through device via openings, a barrier layer (also not independently illustrated) may be formed and the remainder of the through device via openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer (not shown), filling and overfilling the through device via openings. Once the through device via openings have been filled, excess liner, barrier layer, seed layer, and first conductive material outside of the through device via openings may be removed through a planarization process such as chemical mechanical polishing (CMP), although any suitable removal process may be used.

Optionally, in some embodiments once the first through device vias 901 have been formed, second metallization layers (not separately illustrated in FIG. 9) may be formed in electrical connection with the first through device vias 901. In an embodiment the second metallization layers may be formed as described above with respect to the first metallization layers 501, such as being alternating layers of dielectric and conductive materials using damascene processes, dual damascene process, or the like. In other embodiments, the second metallization layers may be formed using a plating process to form and shape conductive material, and then cover the conductive material with a dielectric material. However, any suitable structures and methods of manufacture may be utilized.

The third bonding layer 903 is formed in order to provide electrical connections between the optical interposer 100 and subsequently attached devices. In an embodiment the third bonding layer 903 may be similar to the first bonding layer 505, such as having third bond pads 909 (similar to the first bond pads 507) and even fifth optical components 911 (similar to the third optical components 511). However, any suitable devices may be utilized.

Optionally at this point in the process, an optical fiber 905 may be attached. In an embodiment the optical fiber 905 is utilized as an optical input/output port to the optical interposer 100. In an embodiment the optical fiber 905 is placed so as to optically couple the optical fiber 905 and an optical input such as a grating coupler (not separately illustrated in FIG. 9) that is part of the first optical components 203, the second optical components 503, or the third optical components 511. By positioning the optical fiber 905 as such, optical signals leaving the optical fiber 905 are directed towards, e.g., the first active layer 201 of first optical components 203 and the grating coupler 204. Similarly, the optical fiber 905 is positioned so that optical signals leaving the first active layer 201 of first optical components 203 is directed into the optical fiber 905 for transmission. However, any suitable location may be utilized.

The optical fiber 905 may be held in place using, e.g., an optical glue 907. In some embodiments, the optical glue 907 comprises a polymer material such as epoxy-acrylate oligomers, and may have a refractive index between about 1 and about 3. However, any suitable material may be utilized.

Additionally, while the optical fiber 905 is illustrated as being attached at this point in the manufacturing process, this is intended to be illustrative and is not intended to be limiting. Rather, the optical fiber 905 may be attached at any suitable point in the process. Any suitable point of attachment may be utilized, and all such attachments at any point in the process are fully intended to be included within the scope of the embodiments.

By utilizing the structures and methods presented herein, a bidirectional grating coupler can be integrated into a silicon photonics platform, in which the grating coupler can achieve higher coupling efficiency. Additionally, the bidirectional grating coupler is suitable for different wavelengths of light sources, and has a high wavelength selectivity, making it applicable to different optical systems. Further, multilayer bidirectional grating coupler structures can achieve coupling with wider bandwidths and higher coupling efficiency, while also reducing polarization dependence.

In an embodiment, a method of forming an optical device including: forming a first set of gratings in a grating layer that is present on a cladding layer; and forming a second set of gratings that is horizontally offset and vertically offset from the first set of gratings. In an embodiment, the grating layer is a single layer. In an embodiment, forming the first set of gratings in the grating layer comprises etching first trenches in an upper face of the grating layer that is opposite a lower face of the grating layer that is in direct contact with the cladding layer. In an embodiment, the first trenches for the first set of gratings include an array of grooves, wherein forming the array of the grooves for the first set of gratings includes etching with an increasing depth from a perimeter of the array of the grooves towards a center of the array of the grooves. In an embodiment, the first set of gratings includes an array of gratings having an increasing height from a perimeter of the array of gratings towards a center of the array of gratings.In an embodiment, forming of the second set of gratings in the grating layer comprises patterning the cladding layer to provide second trenches, and depositing the grating layer on the cladding layer, wherein a portion of the grating layer fills the second trenches to form the second set of gratings. In an embodiment, the grating layer is a multilayered structure. In an embodiment, forming the first set of gratings and the second set of gratings comprises: etching first trenches into a first layer of the multilayered structure for the grating layer; depositing a second layer onto the first layer of the multilayered structure for the grating layer, wherein portions of the second layer filling the first trenches in the first layer provide the second set of gratings; and forming second trenches in an upper surface of the second layer to provide the first set of gratings. In an embodiment, the method further comprises etching third trenches into the cladding layer before forming the first layer of the multilayered structure on the cladding layer, wherein the forming of the first layer of the multilayered structure after the etching of the third trenches into the cladding layer fills the third trenches to form a third set of gratings. In an embodiment, the method further comprises forming the cladding layer on a mirror layer.

In another embodiment, an optical device includes: a single grating layer having a first set of gratings extending in a first direction in a first portion of the single grating layer and a second set of gratings extending in a second direction in a second portion of the single grating layer, the second portion being horizontally offset from the first portion; and a cladding layer in contact with the single grating layer. In an embodiment, at least one of the first set of gratings and the second set of gratings include an array of trenches with an increasing depth from a perimeter of the array of the trenches towards a center of the array of the trenches. In an embodiment, at least one of the first set of gratings and the second set of gratings include an array of gratings having an increasing height from a perimeter of the array of the gratings towards a center of the array of the gratings. In an embodiment, the single grating layer has a reducing tapered width towards a waveguide joining portion. In an embodiment, a mirror layer is present on the cladding layer.

In another embodiment, an optical device includes: a first grating layer present on a cladding layer, the first grating layer having a plurality of trenches; and a second grating layer present on the first grating layer, the second grating layer having a first set of gratings on an upper surface of the second grating layer and a second set of gratings on a lower surface of the second grating layer that interfaces with the first grating layer, wherein the first set of gratings have a height that extends in a first direction, and the second set of gratings extend in a second direction into the plurality of trenches in the first grating layer. In an embodiment, the at least one of the first set of gratings and the second set of gratings includes an array of grooves with an increasing depth from a perimeter of the array of the grooves towards a center of the array of the grooves. In an embodiment, at least one of the first set of gratings and the second set of gratings include an array of gratings having an increasing height from a perimeter of the array of gratings towards a center of the array of gratings. In an embodiment, the optical device further comprises a third set of gratings at an interface of the first grating layer and base cladding layer. In an embodiment, a first majority of the first set of gratings is horizontally offset from a second majority of the second set of gratings, and at least a first edge grating of the first set of gratings and at least a second edge grating of the second set of gratings horizontally overlap at a substantially middle portion of the optical device.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of forming an optical device comprising:
patterning a first plurality of trenches over a substrate;
depositing a first grating layer over and in the first plurality of trenches, wherein portions of the first grating layer in the first plurality of trenches define a first set of gratings; and
patterning a second plurality of trenches in the first grating layer to define a second set of gratings, wherein the first set of gratings is laterally offset from the second set of gratings.

2. The method of claim 1, further comprising:
depositing a cladding layer over the substrate, wherein patterning the first plurality of trenches comprises patterning the first plurality of trenches in the cladding layer.

3. The method of claim 1, further comprising:
depositing a cladding layer over the substrate; and
depositing a second grating layer over the cladding layer, wherein patterning the first plurality of trenches comprises patterning the first plurality of trenches in the second grating layer.

4. The method of claim 3, further comprising:
patterning a third plurality of trenches in the cladding layer, wherein depositing the second grating layer over the cladding layer comprises depositing the second grating layer in the third plurality of trenches to define a third set of gratings.

5. The method of claim 4, wherein the first set of gratings and the second set of gratings overlap the third set of gratings.

6. The method of claim 3, wherein depositing the second grating layer comprises depositing the second grating layer on a planar top surface of the cladding layer.

7. The method of claim 1, wherein the first set of gratings partially overlaps the second set of gratings.

8. The method of claim 7, wherein the first set of gratings partially overlaps the second set of gratings at a center of a grating coupler that comprises the first set of gratings and the second set of gratings.

9. The method of claim 1, wherein the second plurality of trenches increases in depth in a direction towards a middle of the second plurality of trenches.

10. A method of forming an optical device comprising:
depositing a cladding layer over a substrate;
forming a grating coupler over the cladding layer, wherein the grating coupler comprises:
a first set of gratings extending away from the substrate; and
a second set of gratings extending towards the substrate, wherein the first set of gratings is offset from the second set of gratings in a plan view.

11. The method of claim 10, wherein a respective height of each of the first set of gratings is substantially uniform.

12. The method of claim 10, wherein the first set of gratings increases in height in a direction towards a middle of the first set of gratings.

13. The method of claim 10, wherein the first set of gratings partially overlaps the second set of gratings in a cross-sectional view.

14. The method of claim 10, further comprising depositing a mirror layer between the cladding layer and the substrate.

15. The method of claim 10, wherein the first set of gratings and the second set of gratings are provided in a first grating layer that interfaces the cladding layer.

16. A method of forming an optical device comprising:
depositing a cladding layer over a substrate;
forming a grating coupler over the cladding layer, wherein forming the grating coupler comprises:
depositing a first grating layer over a cladding layer and filling a first plurality of trenches, wherein portions of the first grating layer in the first plurality of trenches define a first set of gratings that overlaps a first region of the substrate; and
patterning a second plurality of trenches in the first grating layer to define a second set of gratings that overlaps a second region of the substrate, and wherein the first set of gratings and the second set of gratings extend in opposite directions away from a boundary between the first and second regions of the substrate in a plan view.

17. The method of claim 16 further comprising patterning the first plurality of trenches in the cladding layer.

18. The method of claim 16 further comprising:
depositing a second grating layer over the cladding layer, wherein the first grating layer is deposited over the second grating layer; and
patterning the first plurality of trenches in the second grating layer.

19. The method of claim 16, wherein an edge grating of the first set of gratings and an edge grating of the second set of gratings overlap.

20. The method of claim 16, wherein an edge grating of the first set of gratings and an edge grating of the second set of gratings are laterally offset from each other.
